(19) United States
(12) Patent Application Publication
(10) Pub. No.: US 2014/0014564 A1
(43) Pub. Date: Jan. 16, 2014

(54) Multi-Layer Filter

(71) Applicant: Masakazu Fujii, Rancho Palos Verdes, CA (US)

(72) Inventor: Masakazu Fujii, Rancho Palos Verdes, CA (US)

(21) Appl. No.: 13/545,026

(22) Filed: Jul. 10, 2012

(51) Int. Cl. B01D 29/50

(52) U.S. Cl. 210/238; 210/342

(57) ABSTRACT

The present invention discloses a multi-layer filter. The multi-layer filter comprises an upper part, and a body part. The body part comprises at least two filter layers with different mesh size respectively. By employing the multi-layer filter, it is conveniently and easily to make coffee/tea without residue of ground coffee/tea leaf.

### BACKGROUND OF THE INVENTION

1. Field of the Invention

The present invention is generally related to a filter, and more particularly to a multi-layer filter for brewing tea or coffee.

2. Description of the Prior Art

Tea and coffee are very popular drinks. There are many different methods and tools for making a cup/pot of tea or coffee. For example, in order to filter out the residue of ground coffee or tea leaf, filtering net or filtering paper can be employed for assisting people to making tea or coffee. Generally, it is easy to use filtering net to make tea or coffee, and the filtering net can be reusable. However, when employing the filtering net in the prior art for brewing ground coffee or some tea leaf, the mesh size of the filtering net is too large to perfectly filter out the small particles of the ground coffee and the residue of the tea leaf. Filtering paper is usually used on making coffee with ground coffee, and filter paper can efficiently keep the small particles on the filtering paper. But filtering paper cannot be re-used for many times. So that, it will be a considerable cost and environmental issue for using the filtering paper to make coffee/tea. Besides, the coffee made by filtering paper cannot provide the ground coffee with full-extraction, and need some skill when operating.

In view of the above matter, developing a novel filtering device for tea and/or coffee providing convenience, efficiently filtering, and perfectly flavor tasty is still an important task for the industry.

### SUMMARY OF THE INVENTION

In view of the above background and in order to fulfill the above-mentioned requirements, a new multi-layer filtering device is provided in the present invention.

One subject of the present invention is to provide a multi-layer filtering device. The mentioned multi-layer filtering device provides a brewing condition for full-extraction of ground coffee and/or tea leaf to achieve better flavor and taste.

Another object of the present invention is to provide a multi-layer filtering device. The mentioned multi-layer filtering device provides a filtering portion for efficiently filtering out the small particles of ground coffee or tea leaf.

Still another object of the present invention is to provide a multi-layer filtering device. The mentioned multi-layer filtering device can provide a user to make a flavor and delicious coffee or tea easily and conveniently.

According to above-mentioned objectives, the present invention discloses a multi-layer filtering device. The multi-layer filtering device comprises an upper part, and a body part. The body part comprises a filter portion with multi-layer filtering structure. When making a coffee or tea, the ground coffee or the tea leaf is put inside the body part, and the body part is dipped immersed with hot water. After brewing few minutes for making a coffee or tea, the multi-layer filtering device is removed from hot water, and the small particles of the ground coffee or the tea leaf can also be efficiently kept within the body part by the filter portion. So that the multi-layer filtering device of this application can be conveniently used to make a delicious coffee or tea.

### BRIEF DESCRIPTION OF THE DRAWINGS

FIG. 1 shows a multi-layer filtering device according to this present invention;

FIG. 2 shows the cross-section diagram of a multi-layer filtering device in this present invention; and

FIG. 3 shows the cross-section diagram of another multi-layer filtering device in this present invention.

### DETAILED DESCRIPTION OF THE PREFERRED EMBODIMENTS

What is probed into the invention is multi-layer filtering device. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

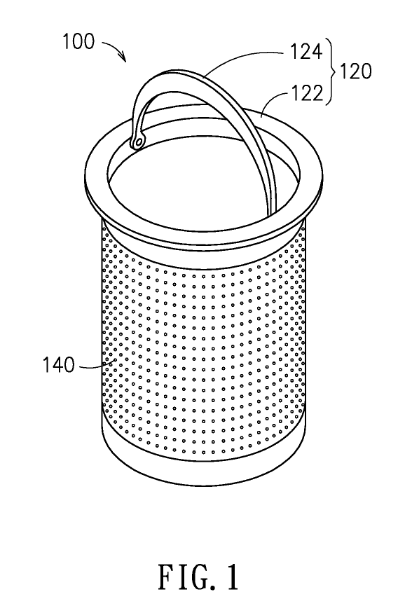

One preferred embodiment of this present invention discloses a multi-layer filtering device. FIG. 1 shows a multi-layer filtering device according to this embodiment. Referred to FIG. 1, the multi-layer filtering device 100 comprises an upper part 120, and a body part 140. The upper part 120 comprises a plate portion 122 surrounding the opening of the multi-layer filtering device 100. In one preferred example, the plate portion 122 is extruding from the upper part 120 and not parallel to the body part 140.

The upper part 120 can further comprise a handle portion 124. As shown in FIG. 1, the handle portion 124 can be positioned onto the upper part 120. In one preferred example, the handle portion 124 can be mounted onto the upper part through two bolts, not shown in the figure. So that the handle portion 124 can be rotated axially by the bolts.

The body part 140 comprises a filter portion. The filter portion at least comprises a first filter layer, and a second filter layer outside the first filter layer. In one preferred example of this embodiment, the size of the meshes of the first filter layer is smaller than the size of the meshes of the second filter layer. In another preferred example of this embodiment, the size of the meshes of the second filter layer is smaller than the size of the meshes of the first filter layer. According to this embodiment, the small particles of the ground coffee or the tea leaf can be efficiently filtered out by the filter portion.

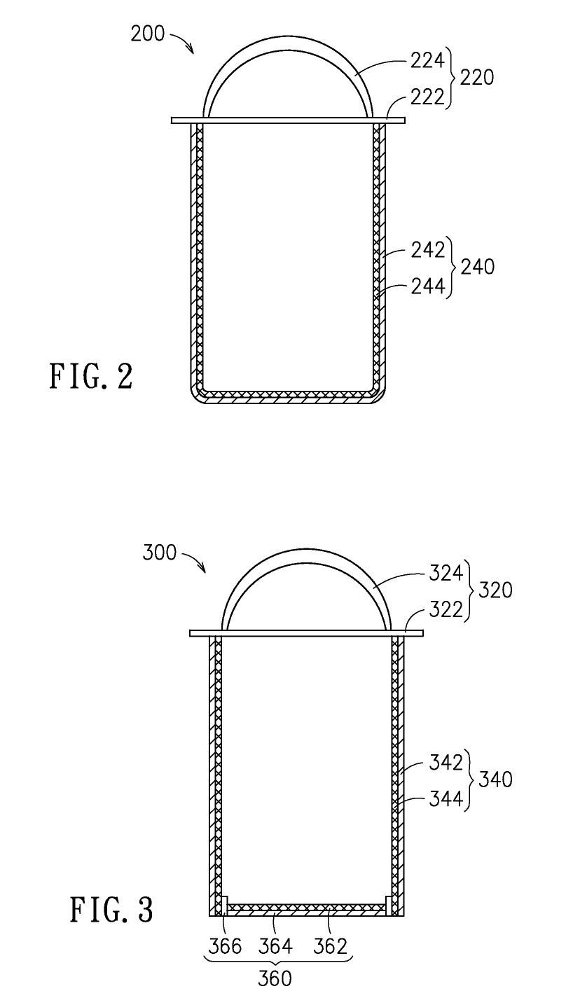

FIG. 2 is a cross-sectional view of one preferred example of the multi-layer filtering device of this embodiment. As shown in FIG. 2, the multi-layer filtering device 200 comprises an upper part 220, and a body part 240. The upper part 220 comprises a plate portion 222, and a handle portion 224. The plate portion 222 is surrounding the opening of the multi-layer filtering device 200, and extruding from the upper part 220. The handle portion 224 is mounted onto the upper part 220 through two bolts, and the handle portion 224 can be rotated axially by the bolts. Referred to FIG. 2, the body part 240 comprises a first filter layer 242, and a second filter layer 244 outside the first layer 242. The mesh size of the first filter layer 242 is different to the mesh size of the second filter layer 244. One of the filter layers is with smaller mesh size for keeping the small particles of ground coffee or the residue of tea leaf. The other filter layer of the body part 240 is with larger mesh size. A filter layer with smaller mesh size can provide better filter performance, but is usually soft. According to this embodiment, the filter layer with larger mesh size can be employed to support the filter layer with smaller mesh size, so that the multi-layer filtering device of this embodiment becomes more conveniently for operating.

FIG. 3 is a cross-sectional view of another preferred example of the multi-layer filtering device of this embodiment. As shown in FIG. 3, the multi-layer filtering device 300 comprises an upper part 320, and a body part. The mentioned body part comprises a side part 340, and a bottom part 360, as shown in FIG. 3. The upper part 320 comprises a plate portion 322, and a handle portion 324. Referred to FIG. 3, the side part 340 and the bottom part 360 can form a cup shape. The side part 340 comprises a first filter layer 342, and a second filter layer 344 outside the first filter layer 342. The mesh size of the first filter layer 342 is different to the mesh size of the second filter layer 344. One of the filter layers of the side part 340 is with smaller mesh size for keeping the small particles of ground coffee or the residue of tea leaf in the cup shape. The other filter layer of the side part 340 is with larger mesh size, and can be employed for support the filter layer with smaller mesh size. The bottom part 360 comprises a third filter layer 362, and a fourth filter layer 364 outside the third filter layer 362, as shown in FIG. 3. One of the filter layers of the bottom part 360 is with smaller mesh size for keeping the small particles of ground coffee or the residue of tea leaf in the cup shape. The other filter layer of the bottom part 360 is with larger mesh size, and additionally can be employed for support the filter layer with smaller mesh size.

According to this invention, it becomes easily and conveniently for anybody to make a coffee from ground coffee, or make a tea from commercial available tea leaf. Firstly, the multi-layer filtering device of this invention is placed into a suitable cup or pot. After putting appropriate amount of ground coffee or tea leaf into the multi-layer filtering device, hot water is poured into the multi-layer filtering device. After few minutes for immersing the ground coffee or tea leaf in the hot water, the multi-layer filtering device is taken out from the cup/pot. According to this invention, the small particles of ground coffee or the residue of tea leaf can be removed from the cup/pot with the multi-layer filtering device. Therefore, with the multi-layer filtering device of this invention, it becomes easily and conveniently for anybody to enjoy a great coffee/tea.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A multi-layer filter comprising:
an upper part, said upper part comprises a plate portion surrounding an opening of the multi-layer filter; and
a body part extending from said upper part, wherein said body part comprise a filter portion, wherein said filter portion comprises a first filter layer and a second filter layer outside said first filter layer, wherein said first filter layer is parallel to said second filter layer, wherein the size of the meshes of said first filter layer is smaller than the size of the meshes of said second filter layer.

2. The multi-layer filter according to claim 1, wherein said plate portion is extruding from said upper part.

3. The multi-layer filter according to claim 1, wherein said plate portion is perpendicular to said body part.

4. The multi-layer filter according to claim 1, wherein said upper part further comprises a handle portion mounted thereon.

5. The multi-layer filter according to claim 4, wherein the handle portion is mounted onto the upper part through two bolts.

6. A multi-layer filter comprising:
an upper part, said upper part comprises a plate portion surrounding an opening of the multi-layer filter; and
a body part extending from said upper part, wherein said body part comprise a filter portion, wherein said filter portion comprises a first filter layer and a second filter layer outside said first filter layer, wherein said first filter layer is parallel to said second filter layer, wherein the size of the meshes of said second filter layer is smaller than the size of the meshes of said first filter layer.

7. The multi-layer filter according to claim 6, wherein said plate portion is extruding from said upper part.

8. The multi-layer filter according to claim 6, wherein said plate portion is perpendicular to said body part.

9. The multi-layer filter according to claim 6, wherein said upper part further comprises a handle portion mounted thereon.

10. The multi-layer filter according to claim 9, wherein the handle portion is mounted onto the upper part through two bolts.
